(19) United States
(12) Patent Application Publication
(10) Pub. No.: US 2014/0279284 A1
(43) Pub. Date: Sep. 18, 2014

(54) NON-TRANSITORY COMPUTER-READABLE STORAGE MEDIUM STORING GAME PROGRAM, AND INFORMATION PROCESSING DEVICE

(71) Applicant: DeNA Co., Ltd., Tokyo (JP)

(72) Inventor: Tomomi HASEYAMA, Tokyo (JP)

(73) Assignee: DeNA Co., Ltd., Tokyo (JP)

(21) Appl. No.: 14/152,841

(22) Filed: Jan. 10, 2014

(30) Foreign Application Priority Data
Mar. 13, 2013 (JP) 2013-051045

(51) Int. Cl. G06Q 30/06

(52) U.S. Cl. CPC G06Q 30/0641
USPC 705/27.1

(57) ABSTRACT

A server device connected to a user terminal via a network receives a request for transmitting a referring web page with multiple guide operation areas, which prompts a user to access linked web pages to guide the user to the linked web pages, are placed from the user terminal via the network, generate the referring web page in which a display state of a guide operation area for which game content has been acquired by the user has been played differs from a display state of a guide operation area for which a game content has not been acquired by the user is to be played on the basis of acquisition information indicating whether game contents have been acquired by the user in games conducted on the linked web pages of the guide operation areas, and transmit the referring web page to the requesting user terminal.

### BACKGROUND OF THE INVENTION

1. Field of the Invention

The present invention relates to a non-transitory computer-readable storage medium storing a game program and an information processing device.

2. Description of Related Art

In network systems for selling products via the Internet, it is known to provide, on a referring web page, display of multiple guide operation areas (such as banners) for guiding users to web pages to which the areas are linked for the purpose of sales promotion (for example, JP 2012-53578 A).

### SUMMARY OF THE INVENTION

With such a network system, users can easily access a linked web page by conducting an operation to select any of multiple guide operation areas and obtain a product associated with the selected guide operation area on the linked web page.

However, although it is possible to allow the user to, while a referring web page is displayed, select each of multiple guide operation areas to easily access all of linked web pages, it is difficult to encourage the use to actually purchase products on all the linked web pages.

The present invention has been made in view of the foregoing, and an objective is to increase users' incentive to acquire products through all of games associated with respective guide operation areas.

A principal invention of the present invention to solve the aforementioned problems is a server device connected to a user terminal used by a user via a network, the server device including:

a receiving unit configured to receive a request for transmitting a referring web page on which multiple guide operation areas, which prompt a user to conduct operation to access linked web pages so as to guide the user to the linked web pages, are placed from the user terminal via a network;

a web page generating unit configured to generate the referring web page in which a display state of a guide operation area guiding to a linked web page on which a game through which a game content is acquired by the user has been played is different from a display state of a guide operation area guiding to a linked web page on which a game through which a game content has not been acquired by the user is to be played on the basis of acquisition information indicating whether or not game contents have been acquired by the user in games conducted on the linked web pages of the guide operation areas; and

a transmitting unit configured to transmit the referring web page generated by the web page generating unit to the requesting user terminal.

Other features of the present invention will be apparent from the description of the present specification and the appended drawings.

According to the present invention, users' incentive to acquire products through all of games associated with respective guide operation areas can be increased.

### BRIEF DESCRIPTION OF THE DRAWINGS

FIG. 1 is a diagram illustrating an overall configuration example of a game system;

FIG. 2 is a block diagram illustrating a functional configuration of a server device;

FIG. 3 is a block diagram illustrating a functional configuration of a user terminal;

FIG. 4 is a table illustrating an example of a data structure of card information;

FIG. 5 is a table illustrating an example of a data structure of user information;

FIG. 6 is a table illustrating an example of a data structure of possessed card information;

FIG. 7 is a table illustrating an example of a data structure of deck information;

FIG. 8 is a table illustrating an example of a data structure of acquisition information;

FIG. 9 is a table illustrating an example of a data structure of banner information;

FIG. 10 is a table illustrating an example of a data structure of video information;

FIG. 11 is a flowchart for explaining an example of operation of the game system;

FIG. 12 is a diagram illustrating an example of My Page on which a banner before changing the display state is placed;

FIG. 13 is a diagram illustrating an example of My Page on which a banner after changing the display state is placed;

FIG. 14 is a diagram illustrating an example of My Page on which a single banner is displayed;

FIG. 15 is a diagram explaining screen transition when a user has selected a banner on My Page illustrated in FIG. 12;

FIG. 16 is a diagram explaining screen transition when a user has selected a banner on My Page illustrated in FIG. 13; and

FIG. 17 is a diagram explaining a change in placement of banners in a banner placement area.

### DETAILED DESCRIPTION OF THE INVENTION

At least the following matters will be apparent according to the description of the present specification and the appended drawings:

A server device connected to a user terminal used by a user via a network, the server device including:

a receiving unit configured to receive a request for transmitting a referring web page on which multiple guide operation areas, which prompt a user to conduct operation to access linked web pages so as to guide the user to the linked web pages, are placed from the user terminal via a network;

a web page generating unit configured to generate the referring web page in which a display state of a guide operation area guiding to a linked web page on which a game through which a game content is acquired by the user has been played is different from a display state of a guide operation area guiding to a linked web page on which a game through which a game content has not been acquired by the user is to be played on the basis of acquisition information indicating whether or not game contents have been acquired by the user in games conducted on the linked web pages of the guide operation areas; and

a transmitting unit configured to transmit the referring web page generated by the web page generating unit to the requesting user terminal.

According to such a server device, the user will attempt to change the display state of all the guide operation areas, which can increase the user's incentive to acquire all the game contents (products) associated with the respective guide operation areas.

Furthermore, in the server device, when a request for transmitting a linked web page is made by the user terminal as a result of selecting a guide operation area by the user, the web page generating unit may make the linked web page to be displayed on the user terminal before a game content is acquired in the game conducted on the linked web page of the guide operation area different from the linked web page to be displayed on the user terminal after a game content is acquired in the game conducted on the linked web page of the guide operation area or make a part in the linked web page to be displayed on the user terminal different between before and after a game content is acquired in the game conducted on the linked web page of the guide operation area.

According to such a server device, a web page or a part of web page based on the state of acquisition of game contents associated with the guide operation areas can be displayed on the user terminal

Furthermore, the server device may further include a number of times determination unit configured to determine whether or not the number of times a guide operation area is selected has reached a predetermined number when the request for transmitting a linked web page is made from the user terminal as a result of selecting the guide operation area by the user,

wherein when the determination by the number of times determination unit is negative, the transmitting unit may transmit a video on a game content that can be acquired in a game conducted on the linked web page of the guide operation area before transmitting the linked web page to the requesting user terminal.

According to such a server device, a video on a game content is presented to the user up to a predetermined number of times, which can further increase the user's incentive to acquire the game contents.

Furthermore, in the server device, when a request for transmitting a linked web page is made by the user terminal as a result of selecting a guide operation area guiding to a linked web page on which a game through which the user has not acquired a game content by the user, the transmitting unit may transmit a video on the game content that has not been acquired before transmitting the linked web page to the requesting user terminal.

According to such a server device, a video on a game content that has not been acquired by a user is displayed on the user terminal, which can further increase the user's incentive to acquire the game content.

Furthermore, in the server device, the web page generating unit may make a position of a guide operation area placed on the referring web page close to a position of an operation area prompting the user to conduct a game operation placed on the linked web page.

According to such a server device, it is possible to facilitate the input operation by the user upon transition from the referring web page to the linked web page.

Furthermore, the server device further may further include a providing unit configured to select a game content from multiple game contents to each of which rarity classified into multiple classes according to rarity values is set when the game on the linked web page is conducted, and provide the user with the selected game content, wherein the web page generating unit may change a display state of a guide operation area guiding to a linked web page on which a game through which the user is provided with a game content is conducted according to the rarity of the game content.

According to such a server device, the user attempts to acquire a game content to which a higher class of rarity is set, which can further increase the user's incentive to acquire the game content.

Furthermore, the server device may further include: a providing unit configured to select a game content from multiple game contents to each of which rarity classified into multiple classes according to rarity values is set when the game on the linked web page is conducted, and provide the user with the selected game content; and a determination unit configured to determine whether or not a game content to which rarity of a predetermined class is provided by the providing unit among the multiple game contents, wherein the web page generating unit may change a display state of a guide operation area guiding to a linked web page on which a game through which the user is provided with a game content is conducted when the determination by the determination unit is positive.

According to such a server device, the user attempts to acquire a game content to which a predetermined class of rarity is set so as to change the display state of the guide operation area, which can further increase the user's incentive to acquire the game content.

Furthermore, in the server device, the web page generating unit may place a guide operation area placement area divided into multiple guide operation areas on the referring web page, and change the placement of the guide operation areas within the guide operation area placement area when a display state of a guide operation area guiding to a linked web page on which a game through which the user has acquired a game content is conducted is changed.

According to such a server device, the user will attempt to fill the guide operation area placement area with the guide operation areas whose display states are changed, which can increase the user's incentive to acquire all the game contents associated with the respective guide operation areas. Furthermore, as a result of changing the position of a guide operation area associated with a game content that has already been acquired, it is possible to clearly distinguish the guide operation area from a guide operation area associated with a game content that has not been acquired, which allows the user to easily conduct an operation to select a guide operation area within the guide operation area placement area.

Furthermore, a non-transitory computer-readable storage medium storing a game program causes a server device connected to a user terminal used by a user via a network to execute:

a process of receiving a request for transmitting a referring web page on which multiple guide operation areas, which prompt a user to conduct operation to access linked web pages so as to guide the user to the linked web pages, are placed from the user terminal via a network;

a process of generating the referring web page in which a display state of a guide operation area guiding to a linked web page on which a game through which a game content is acquired by the user has been played is different from a display state of a guide operation area guiding to a linked web page on which a game through which a game content has not been acquired by the user is to be played on the basis of acquisition information indicating whether or not game contents have been acquired by the user in games conducted on the linked web pages of the guide operation areas; and

a process of transmitting the referring web page generated by the web page generating process to the requesting user terminal.

According to such a program, the user's incentive to acquire all of game contents associated with respective guide operation areas can be increased.

### EMBODIMENT

In an embodiment as follows, a game system 1 that provides game contents, which are digital contents, as products will be described in detail as an example.

<<Configuration of Game System 1>>

FIG. 1 is a diagram illustrating an example of an overall configuration of a game system 1 according to the present embodiment. The game system 1 provides users with various services related to games through a network 2 (for example, the Internet), and includes a server device 10 and a plurality of user terminals 20.

<<Configuration of Server Device 10>>

FIG. 2 is a block diagram illustrating a functional configuration of the server device 10 according to the present embodiment. The server device 10 is an information processing device (for example, a workstation, a personal computer, or the like) used when a system administrator or the like manages the game service. The server device 10 can distribute game programs operable on a user terminal 20, and web pages (such as game screens) made in a markup language (such as HTML) according to the specification of the user terminal 20 upon receiving various commands (requests) from the user terminal 20. The server device 10 includes a control unit 11, a storage unit 12, an input unit 13, a display unit 14, and a communication unit 15.

The control unit 11 is configured to pass data among the units and control the entire server device 10, and is realized by a central processing unit (CPU) executing a program stored in a predetermined memory. The control unit 11 of the present embodiment includes a receiving unit 111, a providing unit 112, a determination unit 113, a battle processing unit 114, a web page generating unit 115, and a privilege granting unit 116.

The receiving unit 111 has a function to execute a process of receiving various operation commands (requests) issued by users from the user terminals 20 via the network 2. The receiving unit 111 of the present embodiment receives requests for transmitting web pages from the user terminals 20 via the network 2.

The providing unit 112 has a function to execute a process of providing users with game contents to be used in games. A game content refers to a game card, a figure or the like associated with a character or the like, or an item or the like such as a tool or an ability that can be used in a game. The providing unit 112 of the present embodiment provides a game card as a game content to be used in a virtual space in a game.

The determination unit 113 has a function to execute various determination processes such as a process of determining whether or not a game card associated with a banner, which is an example of a guide operation area prompting a user to conduct operation to access a linked web page so as to guide the user to the linked web page, is acquired in a game on the linked web page, and a process of determining whether all of game cards associated with respective banners are acquired by a user.

The battle processing unit 114 has a function to execute a process of determining an outcome of a battle against an opponent character. The battle processing unit 114 also has a function to execute an attack process of reducing a hit point parameter value of an opponent character when a user attacked the opponent character.

The web page generating unit 115 has a function to execute a process of generating a web page (such as an operation screen and a game screen) to be displayed on a user terminal 20. The web page generating unit 115 of the present embodiment generates an HTML file as screen data for allowing a web page to be displayed on the user terminal 20. The web page generating unit 115 can describe a banner image file, a URL of a linked web page and the like in association with one another in an HTML file so as to guide a user selecting the banner to the linked web page.

The privilege granting unit 116 has a function to execute a process of granting a privilege to a user satisfying a predetermined condition. Examples of privileges to be granted include special cards and image data, and virtual currency. A predetermined condition is, for example, that a user has acquired all of game cards associated with respective banners.

The storage unit 12 includes a read only memory (ROM) that is a read only storage area in which a system program is stored, and a random access memory (RAM) that is a rewritable storage area used as a work area for arithmetic processing by the control unit 11. The storage unit 12 is, for example, realized by a non-volatile storage device, such as flash memory or a hard disk. The storage unit 12 of the present embodiment stores at least card information that is information on game cards, user information on users, banner information on banners, and video information on video. Details of the information will be described later.

The input unit 13 is used by the system administrator or the like for inputting various data (for example, the card information or the like), and is realized, for example, by a keyboard, a mouse, and the like.

The display unit 14 is used for displaying an operation screen for the system administrator on the basis of a command from the control unit 11, and is realized, for example, by a liquid crystal display (LCD) or the like.

The communication unit 15 is used for performing communication with the user terminals 20, and has a function as a reception unit to receive various data and signals transmitted from the user terminals 20, and a function as a transmitting unit to transmit various data and signals to the user terminals 20 according to commands from the control unit 11. The communication unit 15 is realized, for example, by a network interface card (NIC), or the like.

<<Configuration of User Terminal 20>>

FIG. 3 is a block diagram illustrating a functional configuration of a user terminal 20. The user terminal 20 of the present embodiment is an information processing device (for example, a mobile phone terminal, a smart phone, or the like) used by a user when playing a game, and can request the server device 10 to transmit various types of information (a game program, a web page, or the like) related to the game. The user terminal 20 has a web browser function for allowing the user to browse a web page, and thus can display a web page (a game screen, or the like) delivered from the server device 10. The user terminal 20 includes a terminal control unit 21, a terminal storage unit 22, a terminal input unit 23, a terminal display unit 24, and a terminal communication unit 25.

The terminal control unit 21 is configured to pass data among the units and control the entire user terminal 20, and is realized by a central processing unit (CPU) executing a program stored in a predetermined memory. Note that the terminal control unit 21 of the present embodiment also functions as a screen display control unit that controls a display state of a game screen displayed on the terminal display unit 24. The terminal storage unit 22 is connected to the terminal control unit 21 through a bus, and performs processing of referring to, reading out, or rewriting stored data according to a command from the terminal control unit 21. The terminal storage unit 22 is realized, for example, by flash memory, a hard disk, or the like. The terminal input unit 23 is used for performing various operations (a game operation, and the like) by the user, and is realized, for example, by an operation button, a touch panel, and the like. The terminal display unit 24 is used for displaying a game screen by a command from the terminal control unit 21, and is realized, for example, by a liquid crystal display (LCD) and the like. The terminal communication unit 25 functions as a transmission/reception unit for performing transmission/reception of various types of information to/from the server device 10 through the network 2, and is realized, for example, by a network interface card (NIC), or the like.

<<Data Structure>>

FIG. 4 is a diagram illustrating an example of a data structure of the card information stored in the storage unit 12 of the server device 10. The card information contains items (fields) such as a card ID, a character name, a character image, rarity, an initial attack point, an initial defense point, and an initial hit point. The card ID is identification information for identifying a game card that is an example of the game content. The character name is information indicating a display name of a character associated with a game card. The character image is image data of a character. The rarity is a parameter indicating the degree of rarity classified into a plurality of classes according to a rarity value of a game card. In the present embodiment, six classes of rarity (R1 “common”→R2 “uncommon”→R3 “rare”→R4 “super rare”→R5 “special super rare”→R6 “ultra rare”) are set for game cards (characters). The initial attack point, the initial defense point, and the initial hit point of a character are parameters indicating ability values initially set for the character.

FIG. 5 is a diagram illustrating an example of a data structure of the user information stored in the storage unit 12 of the server device 10. The user information contains items such as a user ID, a virtual currency, possessed card information, deck information, acquisition information, and the like. The user ID is identification information for identifying a user. The virtual currency is an example of a game value and is information indicating the amount of virtual currency possessed by a user. A user can purchase and possess the virtual currency. The possessed card information is information indicating game cards (hereinafter also referred to as possessed cards) possessed by a user. The deck information is information in a deck containing a plurality of game cards. Thus, in the present embodiment, a deck is allotted to each user. The acquisition information is information on a state of acquisition of game cards by a user.

FIG. 6 is a table illustrating an example of a data structure of the possessed card information. The possessed card information contains items such as a possessed card ID, the level of a possessed card, an attack point, a defense point, acquisition date and time, and the like. The possessed card ID is identification information for identifying a possessed card. The possessed card level, the attack point, and the defense point are parameters indicating ability values set for a character associated with a possessed card. These parameters are updated according to a result of a battle game or the like. The acquisition date and time is information indicating the date and time at which a user acquired a possessed card.

FIG. 7 is a table illustrating an example of a data structure of the deck information. The deck information is information defining a game content containing deck (also simply referred to as a “deck”) that is a set of a predetermined number of game cards given to a user. The deck information contains items such as a deck ID, a card ID, rarity, the total number of contained contents, the number of contained contents, and the like.

The deck ID is identification information for identifying each of multiple decks set for each user. In the present embodiment, four decks (deck IDs: 1 to 4) are set for each user. The card ID is identification information for identifying each of multiple game cards contained in each deck. The rarity is index information indicating difficulty in acquiring a game card. In the present embodiment, the data structure is such that a game card with a lower class of rarity is easier to acquire and that a game card with a higher class of rarity is more difficult to acquire. Specifically, as shown in FIG. 7, the deck information is set so that the total number of game cards contained in decks is smaller as the class of rarity of the game cards is higher. Thus, when a game card to be given to a user is selected randomly from game cards contained in a deck, a game card with a higher class of rarity is less likely to be selected.

The total number of contained game cards is information indicating the number of game cards contained in the decks in the initial state. In the present embodiment, the total number of contained game cards with the class or rarity set to the lowest “R1 (common)” is set to “50” as shown in FIG. 7. On the other hand, the total number of contained game cards with the class of rarity set to the highest “R6 (ultra rare)” is set to “1”. In the initial state, the probability that the “R6 (ultra rare)” game card is selected is thus one-fiftieth of the probability that an “R1 (common)” game card is selected.

The number of contained cards is information indicating the number of game cards remaining in decks after a game card is given to a user. The number of contained cards is thus calculated by subtracting the number of game cards given to a user from the total number of contained game cards. The number of contained cards is thus calculated, updated and recorded each time a game card is given.

FIG. 8 is a table illustrating an example of a data structure of the acquisition information. The acquisition information is information indicating a state of acquisition of game cards associated with banners. The acquisition information contains items such as a banner ID, a deck ID, a placement flag, card IDs of game cards acquired by a user in lottery games so far, and the like. The banner ID is identification information for identifying a banner to be displayed on My Page and is associated with a deck ID. The deck ID is identification information for identifying a deck set for a user. In the present embodiment, four decks (deck IDs: 1 to 4) set for a user are each associated with each of four banners (banner IDs: 1 to 4) placed on My Page (a referring web page) of the user. When any of the banners is selected by a user, a lottery game using a deck associated with the banner is conducted on a linked web page, and a game card selected from the multiple game cards contained in the deck is given to the user. The placement flag is information indicating whether or not a game card in a deck is acquired by a user as a result of a lottery game conducted on a linked web page. In the present embodiment, “TRUE” is set to the deck ID of a deck if a game card in the deck is acquired by a user, and “FALSE” is set thereto if no game card in the deck is acquired. The card ID of an acquired game card is data recorded each time a lottery game is conducted (at each number of times of lottery).

FIG. 9 is a table illustrating an example of a data structure of the banner information. The banner information contains items such as a banner ID, an image file, and the like. The banner ID is identification information for identifying a banner to be placed on a web page. The image filed is image data attached as a banner on a web page and is associated with a banner ID.

FIG. 10 is a table illustrating an example of a data structure of the video information. The video information contains items such as a video ID, a video file, and the like. The video ID is identification information for identifying video to be reproduced on a user terminal 20. The video file is video data (such as FLASH (registered trademark)) that can be reproduced by the browser function of the user terminal 20, and is associated with a video ID.

<<Game Outline>>

Here, an outline of a game provided by the game system 1 of the present embodiment will be described. The game system 1 provides various games conducted by using game cards (virtual cards used in a virtual space of a game).

<Battle Game>

In the game system 1 of the present embodiment, a user can possess a plurality of game cards each being associated with a game character. A user can play a battle game by using a game card (character) selected from game cards that the user possesses. The battle processing unit 114 determines an opponent character that battles against the character selected by the user, and determines the outcome of the battle game between these characters on the basis of various parameters (attack points, defense points, hit points, and the like) set for the characters.

<Lottery Game>

With the game system 1 of the present embodiment, a user can play a lottery game called “GACHAGACHA” (registered trademark by consuming a game value (virtual currency) that the user has. A lottery game of the present embodiment is a game to give the user a game card randomly selected from a finite number of game cards contained in a deck. A deck contains game cards to each of which rarity classified into 6 classes (R1 to R6; see FIG. 4) is set in which the number of contained game cards with a higher class of rarity is smaller (see FIG. 7). Thus, a game card with a higher class of rarity is more difficult to acquire. A user can also play a battle game by using a game card acquired in the lottery game.

<Banner Displayed on My Page>

With the game system 1 of the present embodiment, My Page (web page) customized for each user using the game system 1 is set, and a user can access to his/her My Page by using a user terminal 20. My Page contains multiple banners displayed thereon that are an example of guide operation areas to interest the user. URLs of linked web pages in association with the respective banners are described in an HTML file of My Page. Thus, if the user selects any of the banners while My Page is displayed on the user terminal 20, screen transition can be made to a linked web page associated with the selected banner from My Page that is the referring web page.

In the present embodiment, a URL of a game page (web page) for conducting a lottery game is described as a link from each banner in the HTML file of My Page. Furthermore, in a lottery game on each game page, decks associated with each banner are used. When the user selects a banner and starts the lottery game on the linked game page, a game card selected from multiple game cards contained in the decks is given to the user. Each banner displays game cards (such as characters) that can be acquired on the linked game page. The user can select a banner displaying a game card that the user desires to acquire from the banners to access the linked game page and play the lottery game in an attempt of acquiring the desired game card.

Although it is possible to guide the user to any of linked game pages by allowing the user to select each of multiple banners while the referring My Page is displayed on the user terminal 20 as described above, the user might not actually play the lottery games on all the linked game pages.

Thus, with the game system 1 of the present embodiment, multiple banners on the referring My Page are displayed in such a manner that banners for which the lottery games on the linked game pages have been played by the user (game cards are acquired by the user) and banners for which the lottery games have not been played (game cards are not acquired by the user) are displayed in different states. Furthermore, a privilege is granted to a user who played the lottery games on all the linked game pages (a user who acquired game cards in all the lottery games associated with the respective banners). In this manner, users will positively attempt to play the lottery games to change the display states of all the banners and further positively attempt to play the lottery games aiming at acquiring the privilege, which can increase the user's incentive to acquire game cards from all the lottery games associated with the respective banners.

<<Operation of Game System 1>>

FIG. 11 is a flowchart for explaining an example of operation of the game system 1 according to the present embodiment.

First, in a user terminal 20, upon receiving an operation input made by the user from the terminal input unit 23, the terminal control unit 21 transmits a command (My Page transmission request) for acquiring My Page (web page) together with the user ID to the server device 10 (S101).

Subsequently, upon receiving the My Page transmission request together with the user ID transmitted from the user terminal 20 by the receiving unit 111, the server device 10 executes a determination process on the state of display of banners placed on My Page of the user (S102).

Specifically, the determination unit 113 refers to the user information illustrated in FIG. 5 and the acquisition information illustrated in FIG. 8 to determine whether or not a game card is acquired by the user from each of the decks (deck IDs: 1 to 4) for the user used in the lottery games on the linked game pages. If all of the placement flags associated with the respective deck IDs are “FALSE”, no game cards are acquired by the user from all the decks and the determination unit 113 thus determines that no lottery games have been played on the linked game pages of all the banners. If the placement flags associated with the respective decks include “FALSE” and “TRUE”, there are decks from which no game cards are acquired by the user and decks from which game cards are acquired by the user and the determination unit 113 thus determines that there are banners linked to game pages of lottery games that have not been played and banners linked to game pages of lottery games that have been played. If all of the placement flags associated with the respective deck IDs are “TRUE”, game cards are acquired by the user from all the decks and the determination unit 113 thus determines that the lottery games have been played on the linked game pages of all the banners.

Subsequently, after the determination process by the determination unit 113 is executed in this manner and a determination result is obtained, the server device 10 causes the web page generating unit 115 to generate HTML data (screen data) for displaying My Page of the user on the requesting user terminal 20 on the basis of the determination result (S103).

Specifically, if all of the placement flags associated with the deck IDs are determined to be “FALSE”, that is, if it is determined that no lottery games have been played on the linked game pages of all the banners (in other words, if no game cards are acquired by the user from all the lottery games associated with the banners) according to the result of determination, the web page generating unit 115 generates My Page 50 illustrated in FIG. 12 by arranging image files of four banners 521 to 524 obtained from the banner information illustrated in FIG. 9. My Page 50 illustrated in FIG. 12 includes a character display area 51 in which game cards (characters) that the user possesses are displayed, a banner placement area 52 divided into four banners 521 to 524, and a menu display area 53 in which operation buttons that are an example of operation areas are displayed.

If the placement flags associated with the deck IDs include “FALSE” and “TRUE”, that is, if it is determined that lottery games have not been played on the linked game pages of some banners (in other words, if no game cards are acquired by the user from the lottery games associated with some banners) and if it is determined that lottery games have been played on the linked game pages of some banners (in other words, if game cards are acquired by the user from the lottery games associated with some banners) according to the result of determination, the web page generating unit 115 refers to the acquisition information illustrated in FIG. 8, and generates My Page 50 illustrated in FIG. 13 by arranging image files of four banners 522 to 525 obtained from the banner information illustrated in FIG. 9 according to whether or not a game card in each deck is acquired by the user. My Page 50 illustrated in FIG. 13 includes banners 522 to 524 with no mark “ACQUIRED” 54 and a banner 525 with a mark “ACQUIRED” 54 mixed in the banner placement area 52. The mark “ACQUIRED” 54 is an index indicating that the game card associated with the banner has already been acquired by the user. As a result of displaying the banner 525 associated with the game card acquired by the user differently from displaying the banners 522 to 524 associated with the game cards that have not been acquired by the user in this manner, the user will positively select a banner with no mark “ACQUIRED” 54 in an attempt to place the mark “ACQUIRED” 54 on all the banners. As a result, the user's incentive to acquire game cards from all the lottery games associated with the respective banners can be increased.

If all of the placement flags associated with the deck IDs are determined to be “TRUE”, that is, if it is determined that the lottery games have been played on the linked game pages of all the banners (in other words, if game cards are acquired by the user from all the lottery games associated with the respective banners) according to the result of determination, the web page generating unit 115 generates My Page 50 illustrated in FIG. 14 by arranging image files of a single banner 551 obtained from the banner information illustrated in FIG. 9. My Page 50 illustrated in FIG. 14 displays no banner placement area 52 divided into multiple banners as in My Pages 50 illustrated in FIGS. 12 and 13, but displays a banner placement area 55 in which a single banner 551 is placed in the display position corresponding to that of the banner placement area 52. As a result of making the banner placement area 52 divided into multiple banners disappear from My Page in this manner, it is possible to make the user recognize that all the game cards associated with the respective banners are acquired.

If it is determined that the placement flags associated with all the deck IDs are “TRUE” as a result of the determination by the determination unit 113, the privilege granting unit 116 executes a process of granting a privilege to the user.

Referring back to FIG. 11, the server device 10 transmits the HTML file of My Page 50 (web page) generated by the web page generating unit 115 as described above to the requesting user terminal 20 via the network.

Subsequently, upon receiving the HTML file of My Page 50 (web page) transmitted from the server device 10, the user terminal 20 causes the terminal display unit 24 to display My Page 50 (web page) by the browser function (S104).

The user terminal 20 then receives from the user an input of selection of each banner attached to My Page 50 while My Page 50 is displayed on the terminal display unit 24 (S105). For example, if My Page 50 illustrated in FIG. 13 is displayed on the user terminal 20, the user can positively select the banners 522 to 524 with no mark “ACQUIRED” 54 and play the lottery games on the linked game pages so that the mark “ACQUIRED” 54 is placed on all the banners 522 to 524.

Subsequently, when any of the banners displayed on My Page 50 is selected by the user, the user terminal 20 transmits a game page transmission request requesting to transmit the linked game page together with the user ID and the banner ID to the server device 10 (S106).

Subsequently, upon receiving the game page transmission request together with the user ID and the banner ID transmitted from the user terminal 20 by the receiving unit 111, the server device 10 executes a determination process of causing the determination unit 113 to refer to the user information illustrated in FIG. 5 and the acquisition information illustrated in FIG. 8 to determine whether the banner 521 with no mark “ACQUIRED” 54 on My Page 50 illustrated in FIG. 12 is selected by the user and the linked game page transmission request is made, for example, or the banner 525 with the mark “ACQUIRED” 54 on My Page 50 illustrated in FIG. 13 is selected by the user and the linked game page transmission request is made, for example (S107).

Subsequently, after the determination process by the determination unit 113 is executed in this manner and a determination result is obtained, the server device 10 causes the web page generating unit 115 to generate HTML data (screen data) for displaying the linked game page on the requesting user terminal 20 on the basis of the determination result (S108).

Specifically, if the banner 521 with no mark “ACQUIRED” 54 on My Page 50 illustrated in FIG. 12 is selected by the user and the linked game page transmission request is made, for example, according to the determination result, the web page generating unit 115 generates a linked game page 60 illustrated in FIG. 15. The linked game page 60 illustrated in FIG. 15 includes a deck display area 61 (for example, characters to be acquired, the rarity, the attack point, the defense point, the total number, the number and the like of each of the characters) on the decks used in the lottery game, and an operation button 62 for starting the lottery game. In this process, the web page generating unit 115 describes an anchor position, which specifies a part (a part in which the operation button 62 is displayed in the center of the screen) surrounded by a black bold frame in FIG. 15 in the linked game page 60 illustrated in FIG. 15 to be displayed on the user terminal 20, into the HTML file of the linked game page 60. As a result, the user who has not acquired a game card from the lottery game associated with the banner can immediately start the lottery game without any scroll operation on the linked game page 60 after screen transition. Furthermore, the web page generating unit 115 also describes an anchor position, which specifies the position of the banner placed on the referring My Page 50 to be close to the position of the operation button placed on the linked game page 60 after screen transition from the referring My Page 50 to the linked game page 60, into the HTML file of the linked game page 60. As a result, the user can conduct selection operations in a continuous manner before and after screen transition.

Alternatively, if the banner 525 with the mark “ACQUIRED” 54 on My Page 50 illustrated in FIG. 13 is selected by the user and the linked game page transmission request is made, for example, according to the determination result, the web page generating unit 115 generates a linked game page 60 illustrated in FIG. 16. The linked game page 60 illustrated in FIG. 16 is the same as the linked game page 60 illustrated in FIG. 15. The web page generating unit 115, however, describes an anchor position, which specifies a part (a part in which the deck display area 61 is displayed) surrounded by a black bold frame in FIG. 16 in the linked game page 60 illustrated in FIG. 16 to be displayed on the user terminal 20, into the HTML file of the linked game page 60. This is because the lottery game need not be started immediately since the user has already acquired the game card associated with the banner.

Alternatively, in the embodiment described above, if the banner 521 with no mark “ACQUIRED” 54 on My Page 50 illustrated in FIG. 12 is selected by the user and the linked game page transmission is made, for example, the web page generating unit 115 may obtain a video file on a game card (such as character A) associated with the banner 521 from the video information illustrated in FIG. 10 and transmit the video file to the requesting user terminal 20 before transmitting the linked game page to the requesting user terminal 20. As a result, a video on a game card (character) that has not been acquired by the user will be displayed on the user terminal 20, which can further increase the user's incentive to acquire the game card.

Referring back to FIG. 11, the server device 10 transmits the HTML file of the linked game page 60 (web page) generated by the web page generating unit 115 as described above to the requesting user terminal 20 via the network.

Subsequently, upon receiving the HTML file of the linked game page 60 (web page) transmitted from the server device 10, the user terminal 20 causes the terminal display unit 24 to display the linked game page 60 (web page) by the browser function (S109).

Subsequently, when the operation button 62 is selected by the user (S110) while the linked game page 60 is displayed on the terminal display unit 24, the user terminal 20 transmits a command (lottery game start request) for starting the lottery game to the server device 10 through the terminal communication unit 25 (S111).

Subsequently, upon receiving the lottery game start request transmitted from the user terminal 20 by the receiving unit 111, the server device 10 consumes the virtual currency (see FIG. 5) possessed by the user (consumes 100 coins in the present embodiment) and then executes a card giving process through the lottery game (S112).

Specifically, the providing unit 112 refers to the deck information illustrated in FIG. 7 and provides the user with a game card selected using a random number from the deck associated with the banner selected by the user. In this process, the provided game card is additionally recorded as a possessed card of the user into the storage unit 12 to update the possessed card information (see FIG. 5) of the user.

Subsequently, after a game card is given to the user through the lottery game in this manner, the server device 10 transmits an HTML file of a game result page (web page) generated by the web page generating unit 115 to the requesting user terminal 20 through the communication unit 15 (S113).

Subsequently, the user terminal 20 causes the terminal display unit 24 to display the game result page indicating the lottery result by the browser function on the basis of the HTML file of the game result page (web page) transmitted from the server device 10 (S114).

As described above, according to the game system 1 of the present embodiment, multiple banners 521 to 525 on the referring My Page 50 are displayed in such a manner that a banner 525 for which the lottery game on the linked game page 60 has been played by the user (a game card is acquired by the user) and banners 521 to 524 for which the lottery games have not been played (game cards are not acquired by the user) are displayed in different states. In this manner, the user will positively attempt to play the lottery games to change the display states of all the banners, which can increase the user's incentive to acquire game cards associated with the respective banners.

### Other Embodiments

The above-described embodiment has been given for easy understanding of the present invention, and is not to construe the present invention in a limited manner. The present invention can be modified and improved without departing from the gist of the invention and includes its equivalents. In particular, embodiments described below are also included in the present invention.

<Mark 54>

In the above-described embodiment, an example in which the display state of a banner is changed by displaying the mark “ACQUIRED” 54 on a banner associated with a game card already acquired by the user is described, but the present invention is not limited thereto. For example, the display state of a banner may be changed by changing the color of the banner or by changing the shape or the size of the banner.

Furthermore, in the above-described embodiment, an example in which a part of the linked game page 60 displayed on the user terminal 20 differs between when the banner 521 with no mark 54 is selected by the user and when the banner 525 with the mark 54 is selected by the user (see FIGS. 15 and 16) is described, the present invention is not limited thereto. For example, the linked web page displayed on the user terminal 20 may differ between when the banner 521 with no mark 54 is selected by the user and when the banner 525 with the mark 54 is selected by the user.

Furthermore, in the above-described embodiment, an example in which the display state of a banner is changed when a game card in a deck associated with the banner is acquired by the user is described, but the present invention is not limited thereto. For example, the display state of a banner may be changed according to the rarity of a given game card given when the lottery game is played on the linked game page and a game card in a deck associated with the banner is given by the providing unit 112. Specifically, the display state of the banner is changed by increasing the size of the mark 54 as the rarity of the given game card is higher.

Furthermore, in the above-described embodiment, an example in which the display state of a banner is changed when a game card in a deck associated with the banner is acquired by the user is described, but the present invention is not limited thereto. For example, the display state of a banner may be changed if the rarity of a given game card is that of a predetermined class as a result of playing the lottery game on the linked game page, giving a game card in a deck associated with the banner by the providing unit 112, and determining whether or not the rarity of the given game card is that of a predetermined class (for example, determines whether or not the rarity is UR) by the determination unit 113. Alternatively, the display state of a banner may be changed when the lottery game is played on the linked game page and a predetermined specific game card in a deck associated with the banner is given. The predetermined specific game card may be a game card that is a feature of the lottery game (a game card with the highest ability value such as attack point or with the highest rarity, a game card that exhibits a special effect in an event, or the like).

Furthermore, in the above-described embodiment, an example in which the mark 54 is placed on a banner when a game card in a deck associated with the banner is acquired by the user is described, but the present invention is not limited thereto. For example, the number of contained game cards with higher rarities among remaining game cards in the deck associated with the banner may be displayed like “ACQUIRED URI” instead of “ACQUIRED” alone. In this case, the web page generating unit 115 refers to the deck information illustrated in FIG. 7 and the acquisition information illustrated in FIG. 8 to obtain the banner 525 on which the mark 54 like “ACQUIRED URI” is placed from the banner information illustrated in FIG. 9 and place the banner 525 on My Page 50.

<My Page 50>

In the above-described embodiment, an example in which any of My Pages 50 illustrated in FIGS. 12 to 14 is displayed on the user terminal 20 according to the statuses of the placement flags associated with the respective deck IDs in the acquisition information illustrated in FIG. 8 is described, but the present invention is not limited thereto. For example, My Page 50 illustrated in FIG. 14 may display a banner placement area 52 divided into multiple banners 521 to 524 similarly to My Pages 50 illustrated in FIGS. 12 and 13 instead of displaying a single banner 551. In this case, the banner placement area 52 of My Page 50 illustrated in FIG. 14 may display a text of “CHALLENGE FOR 300 COINS!” instead of “CHALLENGE FOR 100 COINS!”. Specifically, the amount of virtual currency to be consumed in the lottery game on the linked game page may be changed when the placement flags of all the decks are “TRUE” (when the user has acquired at least one game card from each of all the decks). Alternatively, the amount of virtual currency to be consumed in the lottery game on the linked game page may be changed if the user selects a banner with the placement flag already changed to “TRUE” when the placement flags associated with the respective decks include “FALSE” and “TRUE”. In one embodiment, the virtual currency to be consumed in the lottery game on the linked game page of a banner with the placement flag “FALSE” is set to be low. When the user pays the currency within the game, acquires a game card through the lottery game on the linked game page of the banner, and the placement flag of the banner is changed to “TRUE”, the virtual currency to be consumed in the lottery game on the linked page of the banner is then set to be higher. Thus, the user can acquire a game card through the lottery game at a low price only for the first time, and at a normal price for the second and subsequent times. As a result, it is possible to produce a feeling of good value in playing the lottery game and lower barriers for the user to acquire a game card through the lottery game on the linked game page of a banner. Furthermore, the lottery games on the linked game pages of all the banners display on My Page may be set as described above, which can further encourage the user to acquire cards from all the links.

<Video Reproduction>

In the above-described embodiment, an example in which a video file is transmitted by the transmitting unit before transmitting a linked game page when the banner 521 with not mark “ACQUIRED” 54 is selected by the user and a linked game page transmission request is received by the receiving unit 111 is described, but the present invention is not limited thereto. For example, the determination unit 113 (number of times determination unit) may determine whether or not the number of times a banner is selected by the user has reached a predetermined number and the transmitting unit may transmit a video file before transmitting a linked game page if the predetermined number has been reached.

<Banner Placement Area 52>

In the above-described embodiment, the arrangement of banners in the banner placement area 52 may be changed. For example, a banner with the mark “ACQUIRED” 54 may be placed at a lower position in the banner placement area 52. Specifically, as illustrated in FIG. 17, it is assumed that a banner of “CHARACTER B” with no mark “ACQUIRED” 54 is selected on MY Page 50 at the present time illustrated on the left and the lottery game using the deck of the “CHARACTER B” is played on the linked web page. Thereafter, in the next My Page 50 illustrated on the right, the banner of “CHARACTER B” with the mark “ACQUIRED” 54 is placed at a lower position in the banner placement area 52 and a banner of “CHARACTER H” with no mark “ACQUIRED” 54 is placed at an upper position in the banner placement area 52. The change in the placement of the banners in this manner facilitates selection of a banner with no mark “ACQUIRED” 54. Specifically, assuming that a part surrounded by a black bold frame in FIG. 17 of My Page 50 is displayed on the screen of the user terminal 20 and focusing on the banner of “CHARACTER H”, it is required to scroll on the screen and select the banner of “CHARACTER H” in My Page 50 of the present time illustrated on the left. In contrast, in the next My Page 50 illustrated on the right, the banner of “CHARACTER H” can be selected without scroll on the screen.

<Server Device>

In the above-described present embodiments, the game system 1 provided with one server device 10 as an example of a server device has been exemplarily described. However, the game system 1 is not limited to this example, and may be provided with a plurality of server devices 10 as an example of the server device. Specifically, a plurality of server devices 10 may be connected through a network 2, and each of the server devices 10 may perform various types of processing in a distributed manner.

<Information Processing Device>

In the above-described game system 1 in the present embodiments, an example in which various types of information processing are executed on the basis of a game program by the server device 10 and the user terminal 20 in cooperation with each other is described. However, the game system 1 is not limited to the example. The various types of information processing may be executed by the user terminal 20 alone or by the server device 10 alone as an information processing device on the basis of a game program.

Furthermore, the user terminal 20 may bear some of the functions of the information processing device. In this case, the server device 10 and the user terminal 20 constitute the information processing device.

What is claimed is:

1. A server device connected to a user terminal used by a user via a network, the server device comprising:
a receiving unit configured to receive a request for transmitting a referring web page on which multiple guide operation areas, which prompt a user to conduct operation to access linked web pages so as to guide the user to the linked web pages, are placed from the user terminal via a network;
a web page generating unit configured to generate the referring web page in which a display state of a guide operation area guiding to a linked web page on which a game through which a game content is acquired by the user has been played is different from a display state of a guide operation area guiding to a linked web page on which a game through which a game content has not been acquired by the user is to be played on the basis of acquisition information indicating whether or not game contents have been acquired by the user in games conducted on the linked web pages of the guide operation areas; and
a transmitting unit configured to transmit the referring web page generated by the web page generating unit to the requesting user terminal,
wherein when a request for transmitting a linked web page is made by the user terminal as a result of selecting a guide operation area by the user, the web page generating unit makes the linked web page to be displayed on the user terminal before a game content is acquired in the game conducted on the linked web page of the guide operation area different from the linked web page to be displayed on the user terminal after a game content is acquired in the game conducted on the linked web page of the guide operation area or makes a part in the linked web page to be displayed on the user terminal different between before and after a game content is acquired in the game conducted on the linked web page of the guide operation area.

2. A server device connected to a user terminal used by a user via a network, the server device comprising:
a receiving unit configured to receive a request for transmitting a referring web page on which multiple guide operation areas, which prompt a user to conduct operation to access linked web pages so as to guide the user to the linked web pages, are placed from the user terminal via a network;
a web page generating unit configured to generate the referring web page in which a display state of a guide operation area guiding to a linked web page on which a game through which a game content is acquired by the user has been played is different from a display state of a guide operation area guiding to a linked web page on which a game through which a game content has not been acquired by the user is to be played on the basis of acquisition information indicating whether or not game contents have been acquired by the user in games conducted on the linked web pages of the guide operation areas;
a transmitting unit configured to transmit the referring web page generated by the web page generating unit to the requesting user terminal; and
a number of times determination unit configured to determine whether or not the number of times a guide operation area is selected has reached a predetermined number when the request for transmitting a linked web page is made from the user terminal as a result of selecting the guide operation area by the user,
wherein when the determination by the number of times determination unit is negative, the transmitting unit transmits a video on a game content that can be acquired in a game conducted on the linked web page of the guide operation area before transmitting the linked web page to the requesting user terminal.

3. A server device connected to a user terminal used by a user via a network, the server device comprising:
a receiving unit configured to receive a request for transmitting a referring web page on which multiple guide operation areas, which prompt a user to conduct operation to access linked web pages so as to guide the user to the linked web pages, are placed from the user terminal via a network;
a web page generating unit configured to generate the referring web page in which a display state of a guide operation area guiding to a linked web page on which a game through which a game content is acquired by the user has been played is different from a display state of a guide operation area guiding to a linked web page on which a game through which a game content has not been acquired by the user is to be played on the basis of acquisition information indicating whether or not game contents have been acquired by the user in games conducted on the linked web pages of the guide operation areas; and
a transmitting unit configured to transmit the referring web page generated by the web page generating unit to the requesting user terminal,
wherein when a request for transmitting a linked web page is made by the user terminal as a result of selecting a guide operation area guiding to a linked web page on which a game through which the user has not acquired a game content by the user, the transmitting unit transmits a video on the game content that has not been acquired before transmitting the linked web page to the requesting user terminal.

4. A server device connected to a user terminal used by a user via a network, the server device comprising:
a receiving unit configured to receive a request for transmitting a referring web page on which multiple guide operation areas, which prompt a user to conduct operation to access linked web pages so as to guide the user to the linked web pages, are placed from the user terminal via a network;
a web page generating unit configured to generate the referring web page in which a display state of a guide operation area guiding to a linked web page on which a game through which a game content is acquired by the user has been played is different from a display state of a guide operation area guiding to a linked web page on which a game through which a game content has not been acquired by the user is to be played on the basis of acquisition information indicating whether or not game contents have been acquired by the user in games conducted on the linked web pages of the guide operation areas; and
a transmitting unit configured to transmit the referring web page generated by the web page generating unit to the requesting user terminal,
wherein the web page generating unit makes a position of a guide operation area placed on the referring web page close to a position of an operation area prompting the user to conduct a game operation placed on the linked web page.

5. A server device connected to a user terminal used by a user via a network, the server device comprising:
a receiving unit configured to receive a request for transmitting a referring web page on which multiple guide operation areas, which prompt a user to conduct operation to access linked web pages so as to guide the user to the linked web pages, are placed from the user terminal via a network;
a web page generating unit configured to generate the referring web page in which a display state of a guide operation area guiding to a linked web page on which a game through which a game content is acquired by the user has been played is different from a display state of a guide operation area guiding to a linked web page on which a game through which a game content has not been acquired by the user is to be played on the basis of acquisition information indicating whether or not game contents have been acquired by the user in games conducted on the linked web pages of the guide operation areas;
a transmitting unit configured to transmit the referring web page generated by the web page generating unit to the requesting user terminal;
a providing unit configured to select a game content from multiple game contents to each of which rarity classified into multiple classes according to rarity values is set when the game on the linked web page is conducted, and provide the user with the selected game content; and
a determination unit configured to determine whether or not a game content to which rarity of a predetermined class is provided by the providing unit among the multiple game contents,
wherein the web page generating unit changes a display state of a guide operation area guiding to a linked web page on which a game through which the user is provided with a game content is conducted when the determination by the determination unit is positive.

6. A server device connected to a user terminal used by a user via a network, the server device comprising:
a receiving unit configured to receive a request for transmitting a referring web page on which multiple guide operation areas, which prompt a user to conduct operation to access linked web pages so as to guide the user to the linked web pages, are placed from the user terminal via a network;
a web page generating unit configured to generate the referring web page in which a display state of a guide operation area guiding to a linked web page on which a game through which a game content is acquired by the user has been played is different from a display state of a guide operation area guiding to a linked web page on which a game through which a game content has not been acquired by the user is to be played on the basis of acquisition information indicating whether or not game contents have been acquired by the user in games conducted on the linked web pages of the guide operation areas; and
a transmitting unit configured to transmit the referring web page generated by the web page generating unit to the requesting user terminal,
wherein the web page generating unit places a guide operation area placement area divided into multiple guide operation areas on the referring web page, and changes the placement of the guide operation areas within the guide operation area placement area when a display state of a guide operation area guiding to a linked web page on which a game through which the user has acquired a game content is conducted is changed.

7. A non-transitory computer-readable storage medium storing a game program causing a server device connected to a user terminal used by a user via a network to execute:
a process of receiving a request for transmitting a referring web page on which multiple guide operation areas, which prompt a user to conduct operation to access linked web pages so as to guide the user to the linked web pages, are placed from the user terminal via a network;
a web page generating process of generating the referring web page in which a display state of a guide operation area guiding to a linked web page on which a game through which a game content is acquired by the user has been played is different from a display state of a guide operation area guiding to a linked web page on which a game through which a game content has not been acquired by the user is to be played on the basis of acquisition information indicating whether or not game contents have been acquired by the user in games conducted on the linked web pages of the guide operation areas; and
a transmitting process of transmitting the referring web page generated by the web page generating process to the requesting user terminal,
wherein when a request for transmitting a linked web page is made by the user terminal as a result of selecting a guide operation area by the user, the web page generating process makes the linked web page to be displayed on the user terminal before a game content is acquired in the game conducted on the linked web page of the guide operation area different from the linked web page to be displayed on the user terminal after a game content is acquired in the game conducted on the linked web page of the guide operation area or makes a part in the linked web page to be displayed on the user terminal different between before and after a game content is acquired in the game conducted on the linked web page of the guide operation area.

8. A non-transitory computer-readable storage medium storing a game program causing a server device connected to a user terminal used by a user via a network to execute:
a process of receiving a request for transmitting a referring web page on which multiple guide operation areas, which prompt a user to conduct operation to access linked web pages so as to guide the user to the linked web pages, are placed from the user terminal via a network;
a web page generating process of generating the referring web page in which a display state of a guide operation area guiding to a linked web page on which a game through which a game content is acquired by the user has been played is different from a display state of a guide operation area guiding to a linked web page on which a game through which a game content has not been acquired by the user is to be played on the basis of acquisition information indicating whether or not game contents have been acquired by the user in games conducted on the linked web pages of the guide operation areas;
a transmitting process of transmitting the referring web page generated by the web page generating process to the requesting user terminal; and
a number of times determination process of determining whether or not the number of times a guide operation area is selected has reached a predetermined number when the request for transmitting a linked web page is made from the user terminal as a result of selecting the guide operation area by the user,
wherein when the determination in the number of times determination process is negative, the transmitting process transmits a video on a game content that can be acquired in a game conducted on the linked web page of the guide operation area before transmitting the linked web page to the requesting user terminal.

9. A non-transitory computer-readable storage medium storing a game program causing a server device connected to a user terminal used by a user via a network to execute:
a process of receiving a request for transmitting a referring web page on which multiple guide operation areas, which prompt a user to conduct operation to access linked web pages so as to guide the user to the linked web pages, are placed from the user terminal via a network;
a web page generating process of generating the referring web page in which a display state of a guide operation area guiding to a linked web page on which a game through which a game content is acquired by the user has been played is different from a display state of a guide operation area guiding to a linked web page on which a game through which a game content has not been acquired by the user is to be played on the basis of acquisition information indicating whether or not game contents have been acquired by the user in games conducted on the linked web pages of the guide operation areas; and
a transmitting process of transmitting the referring web page generated by the web page generating process to the requesting user terminal,
wherein when a request for transmitting a linked web page is made by the user terminal as a result of selecting a guide operation area guiding to a linked web page on which a game through which the user has not acquired a game content by the user, the transmitting process transmits a video on the game content that has not been acquired before transmitting the linked web page to the requesting user terminal.

10. A non-transitory computer-readable storage medium storing a game program causing a server device connected to a user terminal used by a user via a network to execute:
a process of receiving a request for transmitting a referring web page on which multiple guide operation areas, which prompt a user to conduct operation to access linked web pages so as to guide the user to the linked web pages, are placed from the user terminal via a network;
a web page generating process of generating the referring web page in which a display state of a guide operation area guiding to a linked web page on which a game through which a game content is acquired by the user has been played is different from a display state of a guide operation area guiding to a linked web page on which a game through which a game content has not been acquired by the user is to be played on the basis of acquisition information indicating whether or not game contents have been acquired by the user in games conducted on the linked web pages of the guide operation areas; and
a transmitting process of transmitting the referring web page generated by the web page generating process to the requesting user terminal,
wherein the web page generating process makes a position of a guide operation area placed on the referring web page close to a position of an operation area prompting the user to conduct a game operation placed on the linked web page.

11. A non-transitory computer-readable storage medium storing a game program causing a server device connected to a user terminal used by a user via a network to execute:
a process of receiving a request for transmitting a referring web page on which multiple guide operation areas, which prompt a user to conduct operation to access linked web pages so as to guide the user to the linked web pages, are placed from the user terminal via a network;
a web page generating process of generating the referring web page in which a display state of a guide operation area guiding to a linked web page on which a game through which a game content is acquired by the user has been played is different from a display state of a guide operation area guiding to a linked web page on which a game through which a game content has not been acquired by the user is to be played on the basis of acquisition information indicating whether or not game contents have been acquired by the user in games conducted on the linked web pages of the guide operation areas;
a transmitting process of transmitting the referring web page generated by the web page generating process to the requesting user terminal;
a providing process of selecting a game content from multiple game contents to each of which rarity classified into multiple classes according to rarity values is set when the game on the linked web page is conducted, and providing the user with the selected game content; and
a determination process of determining whether or not a game content to which rarity of a predetermined class is provided by the providing process among the multiple game contents,
wherein the web page generating process changes a display state of a guide operation area guiding to a linked web page on which a game through which the user is provided with a game content is conducted when the determination in the determination process is positive.

12. A non-transitory computer-readable storage medium storing a game program causing a server device connected to a user terminal used by a user via a network to execute:
a process of receiving a request for transmitting a referring web page on which multiple guide operation areas, which prompt a user to conduct operation to access linked web pages so as to guide the user to the linked web pages, are placed from the user terminal via a network;
a web page generating process of generating the referring web page in which a display state of a guide operation area guiding to a linked web page on which a game through which a game content is acquired by the user has been played is different from a display state of a guide operation area guiding to a linked web page on which a game through which a game content has not been acquired by the user is to be played on the basis of acquisition information indicating whether or not game contents have been acquired by the user in games conducted on the linked web pages of the guide operation areas; and
a transmitting process of transmitting the referring web page generated by the web page generating process to the requesting user terminal,
wherein the web page generating process places a guide operation area placement area divided into multiple guide operation areas on the referring web page, and changes the placement of the guide operation areas within the guide operation area placement area when a display state of a guide operation area guiding to a linked web page on which a game through which the user has acquired a game content is conducted is changed.
